(19) United States
(12) Patent Application Publication
(10) Pub. No.: US 2007/0045161 A1
(43) Pub. Date: Mar. 1, 2007

(54) SUBSTRATE TREATING APPARATUS

(76) Inventor: Tomoaki AIHARA, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/552,744

(22) Filed: Oct. 25, 2006

(30) Foreign Application Priority Data
Aug. 11, 2005 (JP) 2005-323805

(51) Int. Cl. B01D 33/70

(52) U.S. Cl. 210/150

(57) ABSTRACT

A substrate treating apparatus for treating substrates with a treating liquid is disclosed. The apparatus includes a treating tank for storing the treating liquid, and receiving the substrates for treatment with the treating liquid, a chamber surrounding the treating tank, a lift mechanism vertically movable, while supporting the substrates, between a process position inside the treating tank and a wait position above the treating tank and inside the chamber, an outlet for discharging the treating liquid from the treating tank, and a shutter mechanism for opening and closing an upper part of the treating tank. The shutter mechanism has a lower nozzle for supplying an inert gas containing an organic solvent toward an interior of the treating tank when the shutter mechanism is closed and the treating liquid has been discharged through the outlet.

### BACKGROUND OF THE INVENTION

(1) Field of the Invention

This invention relates a substrate treating apparatus for treating substrates such as semiconductor wafers or glass substrates for liquid crystal displays (hereinafter called simply substrates) with a treating solution or liquid. More particularly, the invention relates to a technique for performing drying treatment of substrates by supplying an inert gas such as nitrogen gas containing an organic solvent such as isopropyl alcohol.

(2) Description of the Related Art

A conventional substrate treating apparatus of this type includes a treating tank for storing treating solutions or liquids and receiving substrates for treatment, a chamber surrounding the treating tank, a lift mechanism for supporting the substrates and vertically movable between a process position inside the treating tank and a wait position above the treating tank and inside the chamber, and nozzles disposed in upper positions inside the chamber for supplying nitrogen gas containing isopropyl alcohol into the chamber (see Japanese Unexamined Patent Publication No. 2004-63513 (FIG. 1), for example).

In the apparatus having the above construction, for example, after performing cleaning treatment of the substrates in the treating tank storing deionized water, nitrogen gas containing isopropyl alcohol is supplied from the nozzles to create a drying atmosphere inside the chamber. Then, the lift mechanism is operated to raise the substrates above the treating tank. The deionized water adhering to the substrates is replaced by the isopropyl alcohol, to promote drying of the substrates.

The conventional apparatus with the above construction has the following drawbacks.

In the conventional apparatus, the nozzles are disposed in high positions inside the chamber in order to avoid interference with the lift mechanism moving the substrates up and down inside the chamber. This results in a drawback of taking a long time to fill a space contributing to drying of the substrates with a drying atmosphere. Further, since the space needing to be filled with the drying atmosphere has a large capacity, there is also a drawback that the use efficiency of isopropyl alcohol is low in the drying treatment of the substrates.

### SUMMARY OF THE INVENTION

This invention has been made having regard to the state of the art noted above, and its object is provide a substrate treating apparatus that can create a drying atmosphere quickly by diminishing a space contributing to drying treatment, thereby enhancing the use efficiency of isopropyl alcohol.

The above object is fulfilled, according to this invention, by a substrate treating apparatus for treating substrates with a treating liquid, comprising a treating tank storing the treating liquid, and receiving the substrates for treatment with the treating liquid; a chamber surrounding the treating tank; a lift mechanism vertically movable, while supporting the substrates, between a process position inside the treating tank and a wait position above the treating tank and inside the chamber; an outlet discharging the treating liquid from the treating tank; a shutter mechanism opening and closing an upper part of the treating tank; and a lower nozzle provided for the shutter mechanism for supplying an inert gas containing an organic solvent toward an interior of the treating tank when the shutter mechanism is closed and the treating liquid has been discharged through the outlet.

According to this invention, the inert gas is supplied from the lower nozzle disposed above the treating tank when the shutter mechanism is closed and the treating liquid has been discharged from the treating tank through the outlet. Thus, it is necessary only to fill a very small space with a drying atmosphere, as compared with the prior art which fills the entire interior of the chamber with the drying atmosphere. The space can be filled quickly with the drying atmosphere, to enhance the use efficiency of the organic solvent.

The apparatus according to the invention may further comprise an upper nozzle provided for the shutter mechanism for supplying the inert gas containing the organic solvent toward the substrates in the wait position when the shutter mechanism is closed and the lift mechanism has been moved to the wait position.

The nitrogen gas containing isopropyl alcohol is further supplied from the upper nozzle to the substrates in the wait position, thereby further promoting drying of the substrates. In addition, lower portions of the substrates which are not dried easily by the lower nozzle alone can also be dried effectively.

The apparatus may further comprise a seal plate disposed below the shutter mechanism and between the treating tank and an inner wall of the chamber to surround a lower position in the chamber

Then, the space to which the inert gas is supplied can be limited to a lower portion of the chamber below the shutter mechanism, thereby improving drying efficiency.

In this invention, the shutter mechanism may have a pair of plate-like members for opening and closing an upper part of the treating tank, the lower nozzle including a lower supply route formed in the plate-like members to be supplied with the inert gas containing the organic solvent, and a plurality of lower feed bores formed in the plate-like members and adjacent the treating tank and communicating with the lower supply route.

When the inert gas is supplied to the lower supply route, the inert gas is supplied through the plurality of lower feed bores. As a result, the inert gas is supplied uniformly to upper portions of the substrates.

The lower nozzle may further include porous members disposed on the plate-like members and adjacent the treating tank.

When the inert gas is supplied to the lower supply route, the inert gas is supplied through the plurality of lower feed bores and porous members. As a result, the inert gas is supplied still more uniformly to the upper portions of the substrates.

The shutter mechanism may have a pair of plate-like members for opening and closing an upper part of the treating tank, the upper nozzle including an upper supply route formed in the plate-like members to be supplied with the inert gas containing the organic solvent, and a plurality of upper feed bores formed in the plate-like members and opposite from the treating tank and communicating with the upper supply route.

When the inert gas is supplied to the upper supply route, the inert gas is supplied through the plurality of upper feed bores. As a result, the inert gas is supplied uniformly to lower portions of the substrates.

The upper nozzle may further include porous members disposed on the plate-like members and opposite from the treating tank.

When the inert gas is supplied to the upper supply route, the inert gas is supplied through the plurality of upper feed bores and porous members. As a result, the inert gas is supplied still more uniformly to the lower portions of the substrates.

In another aspect of the invention, a substrate treating apparatus for treating substrates with a treating liquid comprises a treating tank storing the treating liquid, and receiving the substrates for treatment with the treating liquid; a chamber surrounding the treating tank; a lift mechanism vertically movable, while supporting the substrates, between a process position inside the treating tank and a wait position above the treating tank and inside the chamber; a shutter mechanism opening and closing an upper part of the treating tank; and an upper nozzle provided for the shutter mechanism for supplying an inert gas containing an organic solvent toward the substrates in the wait position when the shutter mechanism is closed and the lift mechanism has been moved to the wait position.

According to this invention, the inert gas is supplied from the upper nozzle disposed above the treating tank when the shutter mechanism is closed and the substrates have been moved to the wait position. Thus, it is necessary only to fill a small space with a drying atmosphere, as compared with the prior art which fills the entire interior of the chamber with the drying atmosphere. The space can be filled quickly with the drying atmosphere, to enhance the use efficiency of the organic solvent. Further, the lower portions of the substrates are subjected to downflow of droplets adhering to the substrates, and do not dry easily. However, with the inert gas supplied from below the substrates, even the lower portions of the substrates can be dried effectively.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus according to the invention;

FIG. 2 is a view in vertical section of a shutter mechanism; and

FIGS. 3 through 6 are explanatory views showing operation of the apparatus.

### DESCRIPTION OF THE PREFERRED EMBODIMENTS

An embodiment of this invention will be described in detail hereinafter with reference to the drawings.

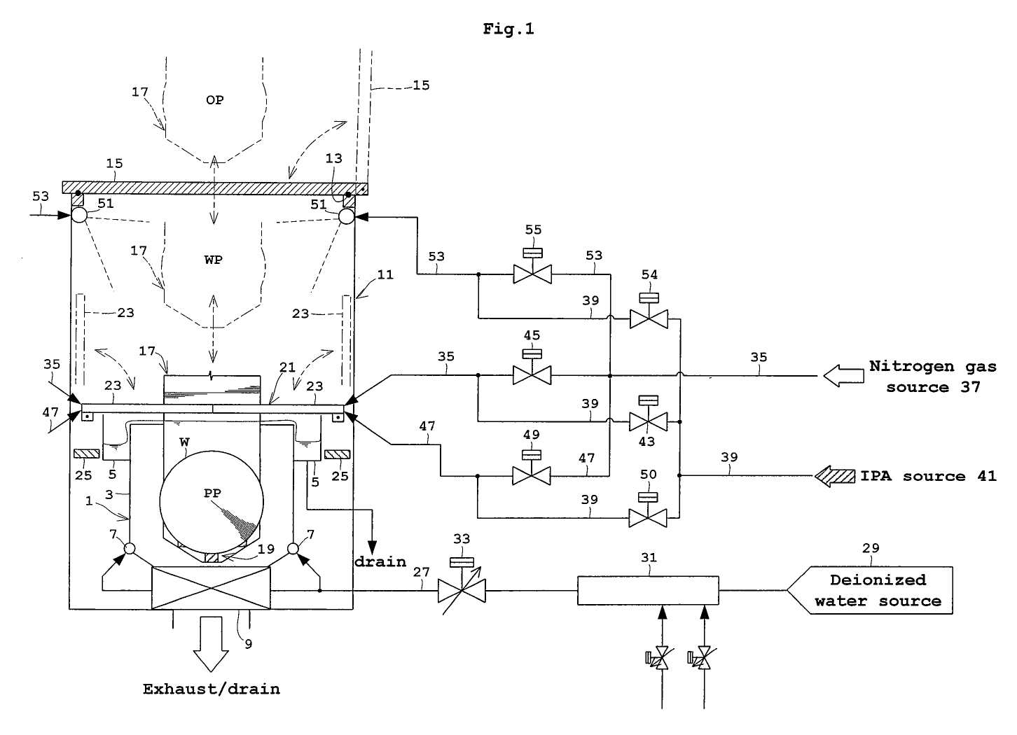

FIG. 1 is a block diagram showing an outline of a substrate treating apparatus according to the invention.

A treating tank 1 stores treating solutions or liquids, and receives wafers W therein for cleaning and etching treatments with the treating liquids. The treating tank 1 includes an inner tank 3 and an outer tank 5. The inner tank 3 has a pair of jet pipes 7 disposed at opposite sides in the bottom thereof for supplying the treating liquids into the inner tank 3, and an outlet 9 formed centrally of the bottom for discharging the treating liquids from the inner tank 3. The outer tank 5 collects and discharges the treating liquids overflowing the inner tank 3.

The entire treating tank 1 is enclosed in a chamber 11. The chamber 11 has a top opening 13 openable and closable by a shutter 15. The chamber 11 has a space and height enough to form a wait position WP above the treating tank 1 for temporarily accommodating the wafers W for drying treatment.

A lift mechanism 17 has a holder 19 vertically movable between a process position PP inside the inner tank 3, the above-mentioned wait position WP, and an outer position OP above the chamber 11. The holder 19 can hold a plurality of wafers W in vertical posture.

A shutter mechanism 21 is disposed above the treating tank 1. The shutter mechanism 21 is formed of a pair of movable plates 23. Each movable plate 23 is pivotable about one end thereof relative to the top of the treating tank 1. The one end of each movable plate 23 is located adjacent an inner wall of the chamber 11, but a gap is deliberately provided therebetween not to block the area completely, since it is necessary to allow a certain amount of gas in the chamber 11 to flow down. As described in detail hereinafter, the movable plates 23 have nozzles formed in upper and lower surfaces thereof.

A seal plate 25 is disposed below the shutter mechanism 21 and between the treating tank 1 and the inner wall of the chamber 11 for loosely partitioning off a lower space in the chamber 11. The seal plate 25 is not a completely blocking structure since it is necessary to permit gas and other substances to circulate to a certain extent in the chamber 11. As described hereinafter, the presence of this seal plate 25 produces an effect of an inert gas supplied downward being restrained from flowing in large quantities into the space below the seal plate 25. This improves the use efficiency of isopropyl alcohol which is an organic solvent.

The jet pipes 7 mentioned above are connected to one end of a supply pipe 27 having the other end connected to a deionized water source 29. The supply pipe 27 has a mixing valve 31 and a control valve 33 arranged from upstream to downstream thereon. The mixing valve 31 introduces two or more types of chemicals into the supply pipe 27. The control valve 33 controls the flow rate of the treating solution through the supply pipe 27, and permits and stops its flow.

The shutter mechanism 21 has one end of a first supply pipe 35 connected thereto. The other end of the first supply pipe 35 is connected to a nitrogen gas source 37. The first supply pipe 35 is in communication with an auxiliary supply pipe 39. The auxiliary supply pipe 39 is connected to an isopropyl alcohol (IPA) source 41. By opening a switch valve 43 mounted on the auxiliary supply pipe 39, isopropyl alcohol is introduced into the first supply pipe 35 to be mixed with nitrogen gas. The first supply pipe 35 has a switch valve 45 mounted thereon upstream of the position of communication with the auxiliary supply pipe 39, for controlling the flow of nitrogen gas through the first supply pipe 35. A second supply pipe 47 branches off from a position of the first supply pipe 35 upstream of the switch valve 45 and the position of communication with the auxiliary supply pipe 39. The second supply pipe 47 is connected to the shutter mechanism 21, and has a switch valve 49 for controlling a flow therethrough. The auxiliary supply pipe 39 is connected to a position of the second supply pipe 47 downstream of the switch valve 49, with a switch valve 50 controlling the flow of isopropyl alcohol to the second supply pipe 47.

Fixed nozzles 51 are arranged in upper positions of the chamber 11 for supplying nitrogen gas, or nitrogen gas containing isopropyl alcohol, into the chamber 11. The fixed nozzles 51 are in communication with one end of a third supply pipe 53 having the other end connected to the first supply pipe 35. The third supply pipe 53 communicates with the first supply pipe 35 upstream of the switch valve 45 and the position of communication with the auxiliary supply pipe 39. The third supply pipe 53 has a switch valve 55 operable to control supply of the nitrogen gas from the fixed nozzles 51. The auxiliary supply pipe 39 is connected to the third supply pipe 53 downstream of the switch valve 55, with a switch valve 54 controlling the flow of isopropyl alcohol to the third supply pipe 53.

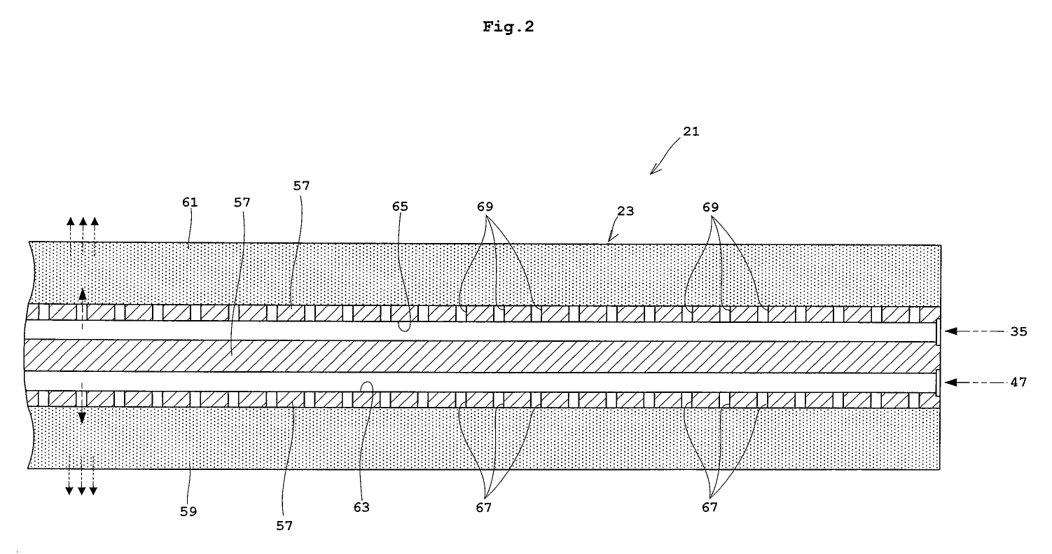

Next, the shutter mechanism 21 mentioned above will be described in detail with reference to FIG. 2. FIG. 2 is a view in vertical section schematically showing the shutter mechanism 21.

The pair of movable plates 23 forming the shutter mechanism 21 have plate-like members 57. Each plate-like member 57 has, formed therein, a lower supply route 63 adjacent the treating tank 1, and an upper supply route 65 opposite from the treating tank 1. Further, each plate-like member 57 has a plurality of lower communication bores 67 formed adjacent the treating tank 1 and communicating with the lower supply route 63, and a plurality of upper communication bores 69 formed opposite from the treating tank 1 and communicating with the upper supply route 65.

The lower supply route 63 is in communication with the second supply pipe 47. The upper supply route 65 is in communication with the first supply pipe 35. Each plate-like member 57 has a lower porous member 59 disposed adjacent the treating tank 1, and an upper porous member 61 disposed opposite from the treating tank 1. When the switch valves 49 and 50 (FIG. 1) are opened, nitrogen gas containing isopropyl alcohol is supplied from the second supply pipe 47 to the lower supply route 63. Then, the nitrogen gas containing isopropyl alcohol is delivered downward through the lower communication bores 67 and lower porous members 59. When the switch valves 43 and 45 (FIG. 1) are opened, the nitrogen gas containing isopropyl alcohol is supplied from the first supply pipe 35 to the upper supply route 65. Then, the nitrogen gas containing isopropyl alcohol is delivered upward through the upper communication bores 69 and upper porous members 61.

The lower supply route 63, second supply pipe 47, lower communication bores 67 and lower porous members 59 constitute the lower nozzle in this invention. The upper supply route 65, first supply pipe 35, upper communication bores 69 and upper porous members 61 constitute the upper nozzle in this invention.

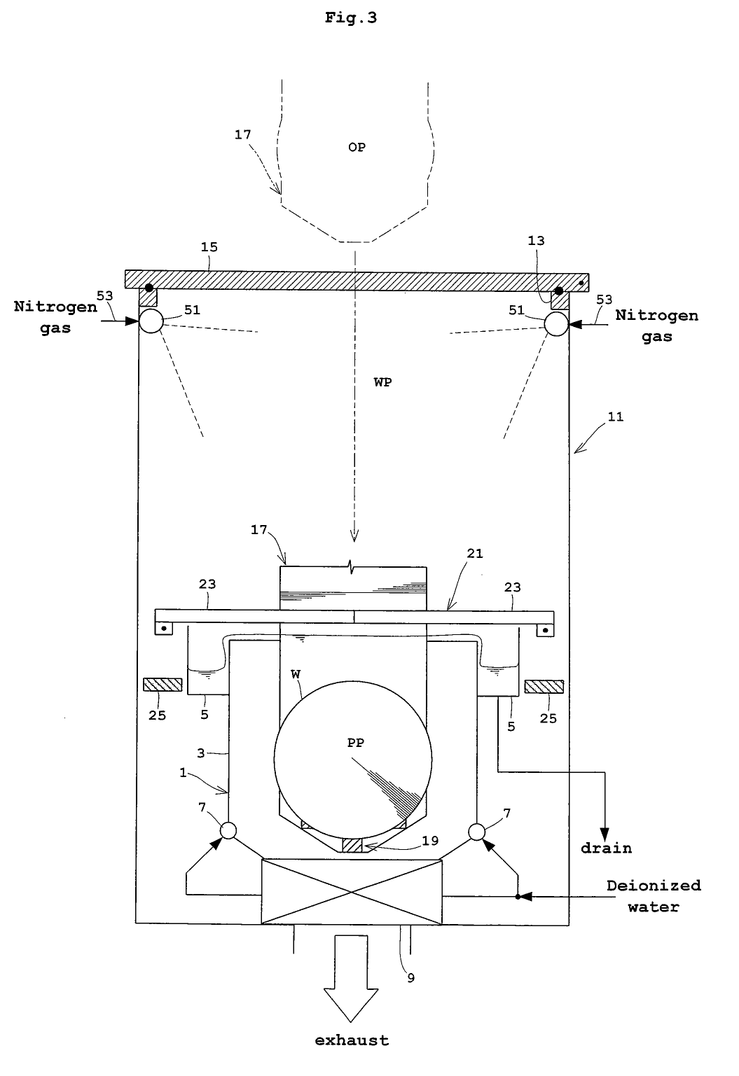

Next, operation of the substrate treating apparatus having the above construction will be described with reference to FIGS. 3 through 6. FIGS. 3 through 6 are explanatory views showing operation of the apparatus.

The shutter 15 and shutter mechanism 21 are opened, and the lift mechanism 17 supporting wafers W is lowered from the outer position OP to the process position PP in the inner tank 3 (FIG. 3). At this time, only the switch valve 55 is opened to supply nitrogen gas from the fixed nozzles 51 into the chamber 11. The gas in the chamber 11 purged by the nitrogen gas passes through the gap between the seal plate 25 and chamber 11 to be discharged from the chamber 11 through the outlet 9 at the bottom of the chamber 11. After the wafers W are moved to the process position PP, the shutter 15 and shutter mechanism 21 are closed. Then, the treating solution containing chemicals is supplied from the pair of jet pipes 7 to the inner tank 3 to carry out a predetermined treatment of the wafers W. Subsequently, only deionized water is supplied as treating liquid from the pair of jet pipes 7 to the inner tank 3. Cleaning treatment with the deionized water is performed for the wafers W for a predetermined time.

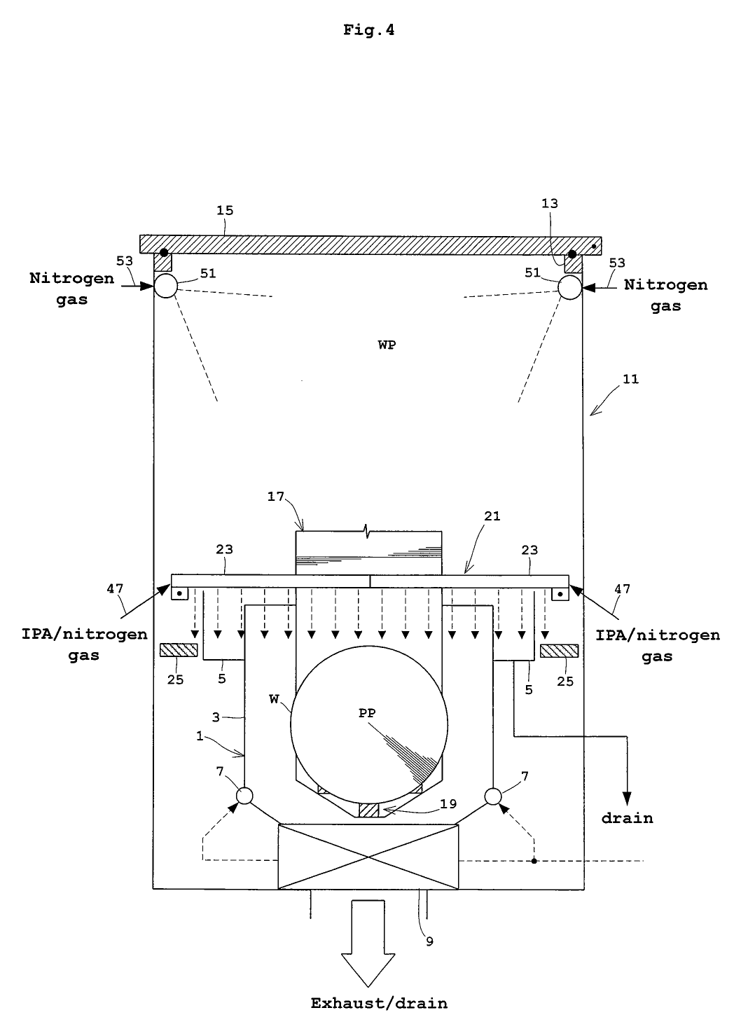

When the cleaning treatment with the deionized water is completed, the outlet 9 is opened to drain the deionized water quickly from the inner tank 3 through the outlet 9, and the switch valves 49 and 50 are opened (FIG. 4). Then, the nitrogen gas containing isopropyl alcohol is supplied to the lower supply route 63 in the plate-like members 57 of the movable plates 23. The wafers W are exposed from the deionized water as a result of the quick drainage. Since the nitrogen gas containing the isopropyl alcohol flows through the lower communication bores 67 and lower porous members 59 down to the wafers W, droplets of the deionized water adhering to the wafers W are replaced by the isopropyl alcohol to promote drying of the wafers W. At this time, the nitrogen gas containing isopropyl alcohol may be supplied only to the interior of the treating tank 1 and to a small space between the shutter mechanism 21 and seal plate 25. Thus, it is necessary only to fill the very small space with a drying atmosphere, as compared with the prior art which fills the entire interior of the chamber 11 with the drying atmosphere. The space can be filled quickly with the drying atmosphere, to enhance the use efficiency of isopropyl alcohol.

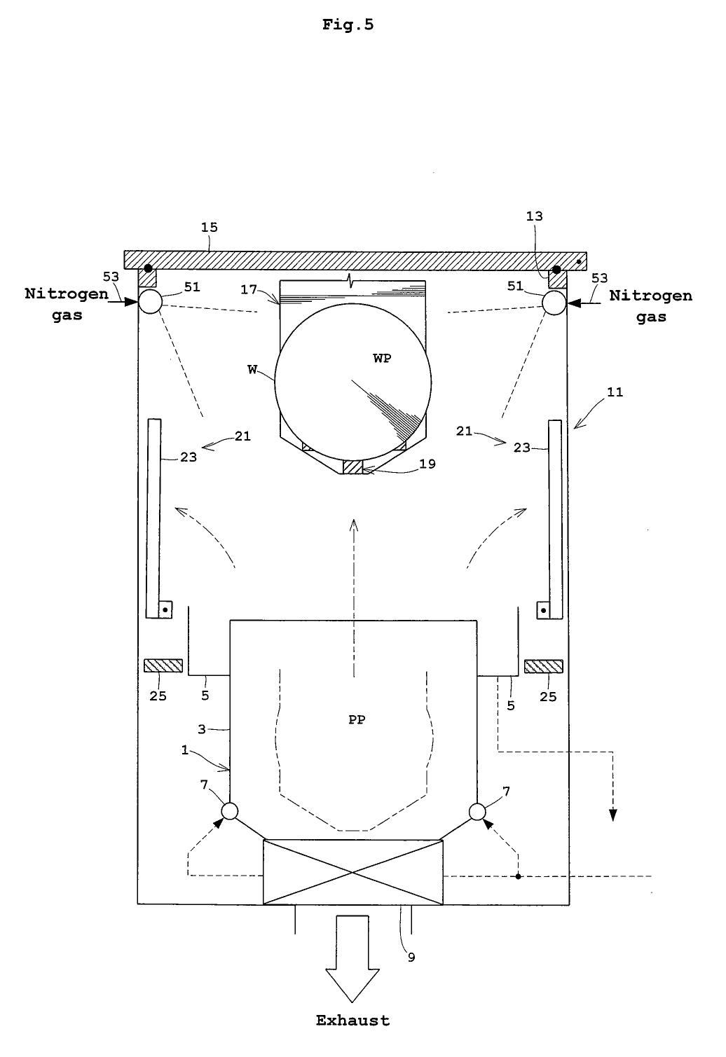

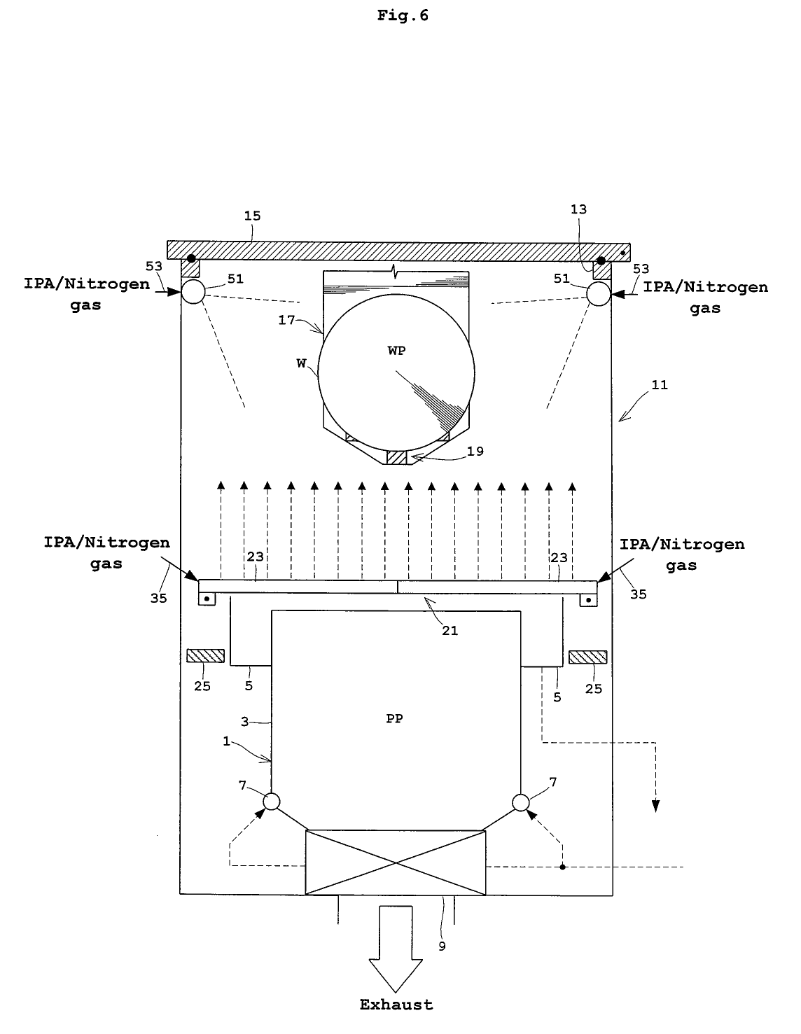

Next, the switch valves 49 and 50 are closed, the shutter mechanism 21 is opened, and the lift mechanism 17 is raised from the process position PP to the wait position WP (FIG. 5). Subsequently, the shutter mechanism 21 is closed, and the switch valves 43 and 45 are opened (FIG. 6). Then, the nitrogen gas containing isopropyl alcohol is supplied to the upper supply route 65 in the plate-like members 57 of the movable plates 23. The nitrogen gas containing isopropyl alcohol is delivered through the upper communication bores 69 and upper porous members 61 upward to lower portions of the wafers W in the wait position WP. At this time, the switch valves 54 and 55 are opened to supply the nitrogen gas containing isopropyl alcohol from the fixed nozzles 51 down toward upper portions of the wafers W in the wait position WP. This process further promotes drying of the wafers W. The lower portions of the wafers W which do not dry easily only with the supply from the above can also be dried effectively.

After the wafers W are maintained in the wait position WP for a predetermined time, the switch valves 43 and 45 are closed and the shutter 15 is opened. The lift mechanism 17 is operated to move the wafers W from the wait position WP out to the outer position OP. This completes the cleaning and drying treatment of the wafers W.

This invention is not limited to the embodiment described above, but may be modified as follows:

(1) It is not absolutely necessary for the shutter mechanism 21 to have both the upper nozzle and lower nozzle, but only the lower nozzle or upper nozzle is sufficient. When only the upper nozzle is provided, drying treatment is carried out by supplying the nitrogen gas containing isopropyl alcohol after the wafers W are moved to the wait position WP. With this construction also, it is sufficient to fill a small space with a drying atmosphere, as compared with the prior art which fills the entire interior of the chamber 11 with the drying atmosphere. The space for the wait position WP can be filled quickly with the drying atmosphere, to enhance the use efficiency of isopropyl alcohol. The lower portions of the wafers W are subjected to downflow of droplets adhering to the wafers W, and do not dry easily. However, with the nitrogen gas supplied from below the wafers W, even the lower portions of the wafers W can be dried effectively.

(2) The shutter mechanism 21 is sized to close a lower part of the chamber 11. Instead, the shutter mechanism 21 may be sized to close only the top of the treating tank 1. With this construction, the space into which the nitrogen gas is supplied is limited to the treating tank 1, which produces the same effect as the foregoing embodiment.

(3) While nitrogen gas mixed with isopropyl alcohol is used in the described embodiment, an inert gas other than nitrogen gas may be employed.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for treating substrates with a treating liquid, comprising:
a treating tank storing the treating liquid, and receiving the substrates for treatment with the treating liquid;
a chamber surrounding said treating tank;
a lift mechanism vertically movable, while supporting the substrates, between a process position inside said treating tank and a wait position above said treating tank and inside said chamber;
an outlet discharging the treating liquid from said treating tank;
a shutter mechanism opening and closing an upper part of said treating tank; and
a lower nozzle provided for said shutter mechanism for supplying an inert gas containing an organic solvent toward an interior of said treating tank when said shutter mechanism is closed and the treating liquid has been discharged through said outlet.

2. An apparatus as defined in claim 1, further comprising an upper nozzle provided for said shutter mechanism for supplying the inert gas containing the organic solvent toward the substrates in the wait position when said shutter mechanism is closed and said lift mechanism has been moved to the wait position.

3. An apparatus as defined in claim 1, further comprising a seal plate disposed below said shutter mechanism and between said treating tank and an inner wall of said chamber to surround a lower position in said chamber

4. An apparatus as defined in claim 2, further comprising a seal plate disposed below said shutter mechanism and between said treating tank and an inner wall of said chamber to surround a lower position in said chamber

5. An apparatus as defined in claim 1, wherein said shutter mechanism has a pair of plate-like members for opening and closing an upper part of said treating tank, said lower nozzle including a lower supply route formed in said plate-like members to be supplied with the inert gas containing the organic solvent, and a plurality of lower feed bores formed in said plate-like members and adjacent said treating tank and communicating with said lower supply route.

6. An apparatus as defined in claim 5, wherein said lower nozzle further includes porous members disposed on said plate-like members and adjacent said treating tank.

7. An apparatus as defined in claim 2, wherein said shutter mechanism has a pair of plate-like members for opening and closing an upper part of said treating tank, said upper nozzle including an upper supply route formed in said plate-like members to be supplied with the inert gas containing the organic solvent, and a plurality of upper feed bores formed in said plate-like members and opposite from said treating tank and communicating with said upper supply route.

8. An apparatus as defined in claim 7, wherein said upper nozzle further includes porous members disposed on said plate-like members and opposite from said treating tank.

9. A substrate treating apparatus for treating substrates with a treating liquid, comprising:
a treating tank storing the treating liquid, and receiving the substrates for treatment with the treating liquid;
a chamber surrounding said treating tank;
a lift mechanism vertically movable, while supporting the substrates, between a process position inside said treating tank and a wait position above said treating tank and inside said chamber;
a shutter mechanism opening and closing an upper part of said treating tank; and
an upper nozzle provided for said shutter mechanism for supplying an inert gas containing an organic solvent toward the substrates in the wait position when said shutter mechanism is closed and said lift mechanism has been moved to the wait position.

10. An apparatus as defined in claim 9, wherein said shutter mechanism has a pair of plate-like members for opening and closing an upper part of said treating tank, said upper nozzle including an upper supply route formed in said plate-like members to be supplied with the inert gas containing the organic solvent, and a plurality of upper feed bores formed in said plate-like members and opposite from said treating tank and communicating with said upper supply route.

11. An apparatus as defined in claim 1, wherein said chamber includes fixed nozzles for supplying the inert gas containing the organic solvent toward the substrates in the wait position when said lift mechanism has been moved to the wait position.

12. An apparatus as defined in claim 2, wherein said chamber includes fixed nozzles for supplying the inert gas containing the organic solvent toward the substrates in the wait position when said lift mechanism has been moved to the wait position.

13. An apparatus as defined in claim 3, wherein said chamber includes fixed nozzles for supplying the inert gas containing the organic solvent toward the substrates in the wait position when said lift mechanism has been moved to the wait position.

14. An apparatus as defined in claim 4, wherein said chamber includes fixed nozzles for supplying the inert gas containing the organic solvent toward the substrates in the wait position when said lift mechanism has been moved to the wait position.

15. An apparatus as defined in claim 5, wherein said chamber includes fixed nozzles for supplying the inert gas containing the organic solvent toward the substrates in the wait position when said lift mechanism has been moved to the wait position.

16. An apparatus as defined in claim 6, wherein said chamber includes fixed nozzles for supplying the inert gas containing the organic solvent toward the substrates in the wait position when said lift mechanism has been moved to the wait position.

17. An apparatus as defined in claim 7, wherein said chamber includes fixed nozzles for supplying the inert gas containing the organic solvent toward the substrates in the wait position when said lift mechanism has been moved to the wait position.

18. An apparatus as defined in claim 8, wherein said chamber includes fixed nozzles for supplying the inert gas containing the organic solvent toward the substrates in the wait position when said lift mechanism has been moved to the wait position.

19. An apparatus as defined in claim 9, wherein said chamber includes fixed nozzles for supplying the inert gas containing the organic solvent toward the substrates in the wait position when said lift mechanism has been moved to the wait position.

20. An apparatus as defined in claim 10, wherein said chamber includes fixed nozzles for supplying the inert gas containing the organic solvent toward the substrates in the wait position when said lift mechanism has been moved to the wait position.
